(19) United States
(12) Patent Application Publication
(10) Pub. No.: US 2010/0148614 A1
(43) Pub. Date: Jun. 17, 2010

(54) Rotor for synchronous motor

(75) Inventors: Che-o Park, Suwon-si (KR); Hyung-chul Lee, Gunpo-si (KR); Chun-mo Sung, Hwaseong-si (KR); Sang-yong An, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELETRONICS CO., LTD., Suwon-si (KR)

(21) Appl. No.: 12/461,302

(22) Filed: Aug. 6, 2009

(30) Foreign Application Priority Data
Dec. 17, 2008 (KR) 10-2008-0128319

(51) Int. Cl. H02K 1/27

(52) U.S. Cl. 310/156.83

(57) ABSTRACT

A rotor for a synchronous motor includes a main core which is formed with a shaft hole disposed in a center area thereof, a plurality of inductive conductor slots arranged along an outer area thereof, and a plurality of magnet slots each arranged between the shaft hole and the inductive conductor slots; an inductive conductor which is inserted into each inductive conductor slot; a first and a second permanent magnet units which each have at least one first permanent magnet and at least one second permanent magnet having different polarities, the first permanent magnet and the second permanent magnet being inserted into the magnet slots and being disposed opposite to each other with the shaft hole being interposed therebetween; and a magnetic flux loss prevention member which is disposed between the first permanent magnet unit and the second permanent magnet unit and prevents loss of magnetic flux, intervals between the inductive conductor slots become small as the inductive conductor slots go from centers of the first and second permanent magnet units to the magnetic flux loss prevention member. Thus, intervals of inductive conductor slots in which inductive conductors are inserted become small as the inductive conductor slots go from centers of permanent magnet units to a magnetic flux loss prevention member, and thus, torque ripple generated in a portion where polarities of permanent magnets are changed in driving a synchronous motor is prevented, thereby reducing vibrations and noises.

### CROSS-REFERENCE TO RELATED APPLICATIONS

This application claims priority from Korean Patent Application No. 10-2008-0128319, filed on Dec. 17, 2008 in the Korean Intellectual Property Office, the disclosure of which is incorporated herein by reference.

### BACKGROUND

1. Field

Apparatuses and methods consistent with the present invention relate to a rotor for a synchronous motor which is improved in an arrangement of inductive conductor slots.

2. Description of the Related Art

In general, a motor converts electrical energy into mechanical energy and obtains a rotational force.

The motor may be classified as an alternating current motor a direct current motor.

A line start permanent magnet (LSPM) synchronous motor, which is a kind of alternating current motor may obtain a stable rotational characteristic in synchronization with an input frequency. The LSPM synchronous motor varies power frequency, to thereby easily vary a rotational speed of the motor.

In the LSPM synchronous motor, if power is applied to a coil of a stator, a rotor disposed inside of the stator is rotated.

In an initial operation of the motor, the rotor begins rotating by a magnetic action generated between a conductor of the stator and a plurality of inductive conductors of the rotor.

Then, if a rotational speed of the rotor reaches a synchronous speed which is a rotational speed of a magnetic field generated by the stator, the rotor is rotated at the synchronous speed by a magnetic action generated between a primary conductor of the stator and a permanent magnet of the rotor.

In a conventional rotor for a synchronous motor, a plurality of inductive conductor slots is regularly arranged regardless of positions of permanent magnets, and thus, torque ripple is generated in driving the synchronous motor, thereby causing vibration and noise. Further, the amount of magnetic flux which is directed from the permanent magnets to a stator is reduced, thereby deteriorating efficiency of the synchronous motor.

### SUMMARY

Additional aspects and/or advantages will be set forth in part in the description which follows and, in part, will be apparent from the description, or may be learned by practice of the invention.

According to an exemplary embodiment, there is provided a rotor for a synchronous motor, including: a main core which is formed with a shaft hole disposed in a center area thereof, a plurality of inductive conductor slots arranged along an outer area thereof, and a plurality of magnet slots each arranged between the shaft hole and the inductive conductor slots; an inductive conductor which is inserted into each inductive conductor slot; a first and a second permanent magnet units which each have at least one first permanent magnet and at least one second permanent magnet having different polarities, the first permanent magnet and the second permanent magnet being inserted into the magnet slots and being disposed opposite to each other with the shaft hole being interposed therebetween; and a magnetic flux loss prevention member which is disposed between the first permanent magnet unit and the second permanent magnet unit and prevents loss of magnetic flux, intervals between the inductive conductor slots become small as the inductive conductor slots go from centers of the first and second permanent magnet units to the magnetic flux loss prevention member.

The plurality of inductive conductor slots may be arranged in an oval shape around the center of the shaft hole.

The plurality of magnet slots may be arranged along an elliptical circle formed by the plurality of inductive conductor slots.

An elliptical circle formed by the plurality of inductive conductor slots may have a maximum radius on a line which connects centers of the first and second permanent magnet units, and may have a minimum radius on a line perpendicular to the line which connects the centers of the first and second permanent magnet units.

The maximum radius may be about 0.707 to about 0.861 times longer than a radius of the main core; and the minimum radius may be about 0.631 to about 0.707 times longer than the radius of the main core.

Cross-sectional areas of the inductive conductor slots become big as the inductive conductor slots may go from centers of the first and second permanent magnet units to the magnetic flux loss prevention member.

The plurality of inductive conductor slots may have the same cross-sectional shapes and sizes.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a perspective view of a rotor for a synchronous motor according to an exemplary embodiment;

FIG. 2 is a cross-sectional view of the rotor in FIG. 1;

FIG. 3 is a cross-sectional view of the rotor in FIG. 1 in which permanent magnet units are not shown for illustrating arrangement of inductive conductor slots;

FIG. 4 is an enlarged view of the rotor in FIG. 2 illustrating arrangement of inductive conductor slots;

FIG. 5 is a cross-sectional view of a rotor for a synchronous motor according to another exemplary embodiment of the present invention; and

FIG. 6 is a cross-sectional view of a line start permanent magnet (LSMP) synchronous motor having the rotor according to an exemplary embodiment.

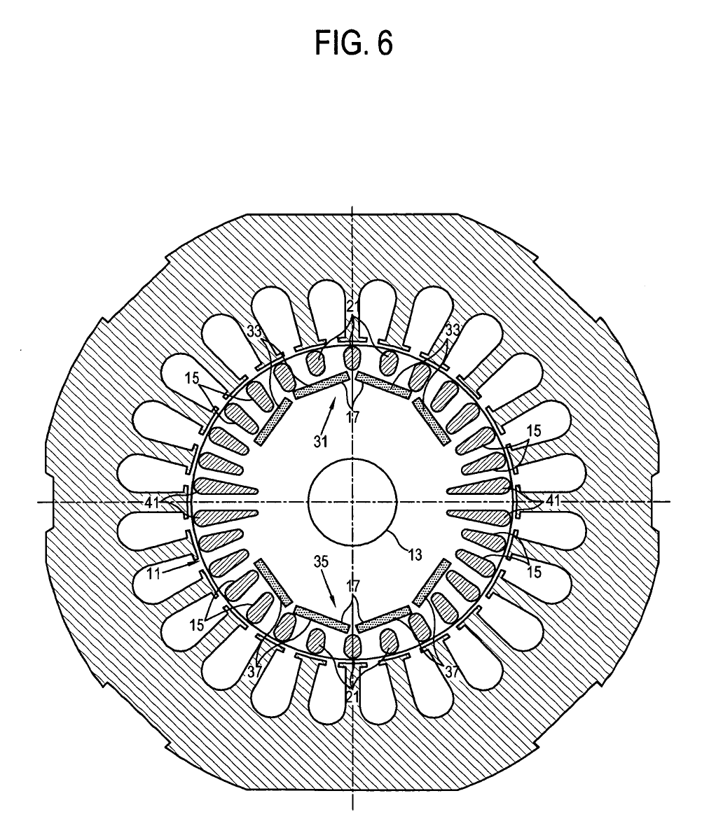

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

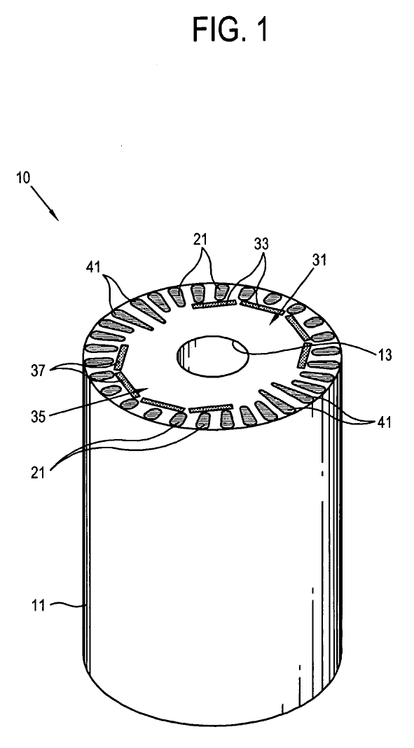

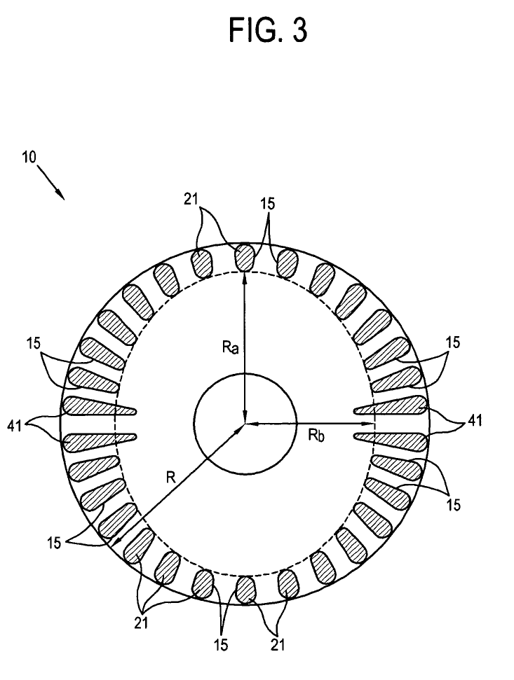

FIGS. 1 to 4 illustrate a rotor for a synchronous motor according to an exemplary embodiment.

A rotor 10 for a synchronous motor according an embodiment includes a main core 11, a plurality of inductive conductors 21, a first permanent magnet unit 31, a second permanent magnet unit 35, and a magnetic flux loss prevention member 41.

The main core 11 has a cylindrical shape in which a plurality of thin plates is laminated. In the main core 11 are formed a shaft hole 13, a plurality of inductive conductor slots 15, and a plurality of magnet slots 17.

The shaft hole 13 is formed through a center area of the main core 11. In the shaft hole 13 is inserted a shaft (not shown) which rotates together with the main core 11.

The plurality of inductive conductor slots 15 is formed around the shaft hole 13 along an outer area of the main core 11. The plurality of inductive conductor slots 15 is arranged in an oval shape around the shaft hole 13. An elliptical circle formed by connecting inner end points of the plurality of inductive conductor slots 15 has a maximum radius Ra on a line which connects centers of the permanent magnet units 31 and 35 and has a minimum radius Rb on a line perpendicular to the line which connects the centers of the permanent magnet units 31 and 35. The maximum radius Ra may be about 0.707 to about 0.861 times as long as a radius R of the main core; and the minimum radius Rb may be about 0.631 to about 0.707 times as long as than the radius R of the main core.

Further, intervals of the plurality of inductive conductor slots 15 become small gradually as the inductive conductor slots 15 go from centers of the permanent magnet units 31 and 35 to the magnetic flux loss prevention member 41.

Furthermore, cross-sectional shapes of the plurality of inductive conductor slots 15 become big, that is, the cross-sectional shapes become long and the cross-sectional areas thereof increase, as the inductive conductor slots 15 go from centers of the permanent magnet units 31 and 35 to the magnetic flux loss prevention member 41. In this respect, an arrangement of the inductive conductor slots 15 and the number thereof may vary according to a characteristic of the synchronous motor.

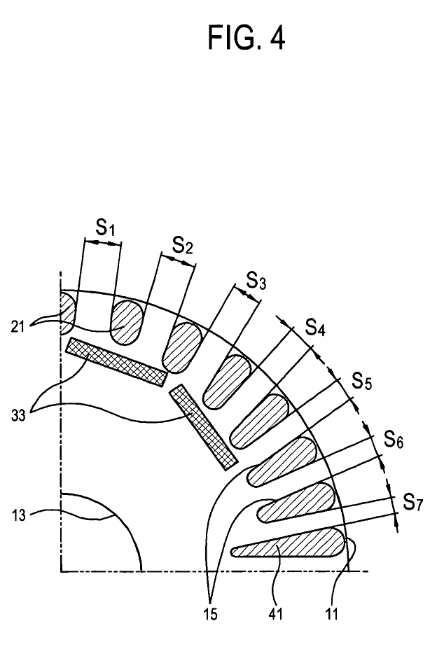

FIG. 4 illustrates an arrangement of the inductive conductor slots 15 of the rotor.

If there are provided seven slots between a center of a first permanent magnet unit 31 and a center of the magnetic flux loss prevention member 41, an interval Sn between an n-th inductive conductor slot 15 and an (n+1)-th inductive conductor slot 15 can be expressed as the following equation:

Sₙ=S₁*0.9ⁿ⁻¹

Here, S₁ refers to an interval between a first inductive conductor slot 15 and a second inductive conductor slot 15.

Accordingly, the intervals between the inductive conductor slots 15 become small gradually as the inductive conductor slots 15 go from the centers of the permanent magnet units 31 and 35 to the magnetic flux loss prevention member 41.

Into the inductive conductor slots 15 are inserted the inductive conductors 21. The inductive conductors 21 enable an inductive current induced from the stator to flow smoothly. The inductive conductors 21 may be made of various materials having non-magnetic conductivity, such as aluminum having superior formability and workability.

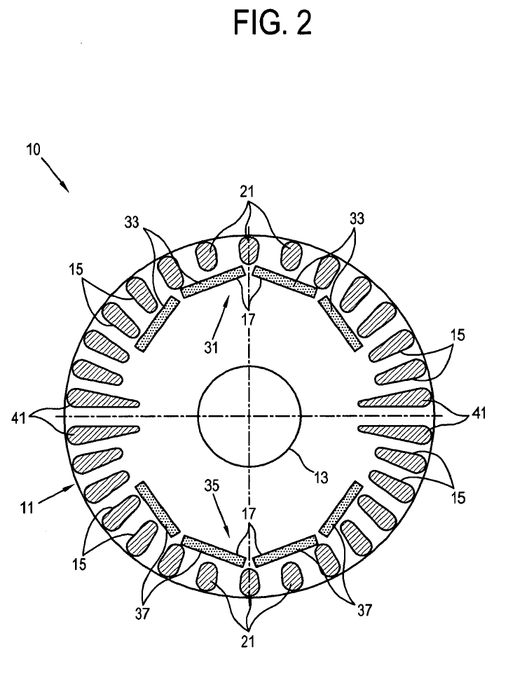

As shown in FIG. 2, the plurality of magnet slots 17 is arranged inside the inductive conductor slots 15. The plurality of magnet slots 17 is arranged opposite to each other with the shaft hole 13 being interposed therebetween, and are symmetrically arranged around the centers of the permanent magnet units 31 and 35. More specifically, the plurality of magnet slots 17 according to the embodiment is arranged along the elliptical circle formed by the plurality of inductive conductor slots 15, thereby increasing an effective cross-sectional area for insertion of permanent magnets 33 and 37, reducing loss of magnetic flux and improving efficiency of the synchronous motor. In this respect, an arrangement of the magnet slots 17 and the number thereof may vary according to a characteristic of the synchronous motor.

The above-described magnet slots 17 correspond to the first permanent magnet unit 31 and the second permanent magnet unit 35, respectively. Into the magnet slots 17 corresponding to the first permanent magnet unit 31 are inserted first permanent magnets 33; and into the magnet slots 17 corresponding to the second permanent magnet unit 35 are inserted second permanent magnets 37 having polarity different from the first permanent magnets 33. The first permanent magnets 33 and the second permanent magnets 37 form a magnetic flux path along an outer area of the main core 11.

The magnetic flux loss prevention member 41 is disposed between the first permanent magnet unit 31 and the second permanent magnet unit 35. Air is filled in the magnetic flux loss prevention member 41 to prevent loss of magnetic flux of the permanent magnets 33 and 37. Two pairs of magnetic flux loss prevention members 41 having approximately a wedge shape are disposed opposite to each other with the shaft hole 13 interposed therebetween, but the shape of the magnetic flux loss prevention member 41 and the number thereof may vary according to a characteristic of the synchronous motor according to an embodiment.

With the above-described configuration, if power is applied to a coil in a stator, the rotor 10 is rotated inside the stator.

The rotor 10 begins rotating by a magnetic force generated between the conductor of the stator and the plurality of inductive conductors 21 of the rotor 10. That is, the rotor 10 rotates by an induction motor principle.

In this respect, since the intervals of the inductive conductor slots 15 become small as the inductive conductor slots 15 go from the centers of the permanent magnet units 31 and 35 having the strongest magnetic force to the magnetic flux loss prevention member 41 having the smallest magnetic force, a secondary inductive current induced to the inductive conductor 21 is increased, or a secondary inductive current induced by interaction of a secondary inductive voltage induced to the inductive conductor 21 and magnetic flux of the permanent magnets 33 and 37 is increased. Accordingly, fluctuation in the second inductive voltage induced to the rotor 10 becomes smooth according to a rotational angle of the rotor 10, and thus, torque ripple generated in a portion in which polarities of the permanent magnets 33 and 37 are changed is prevented, thereby reducing vibration and noise. Further, since the intervals of the inductive conductor slots 15 become big as the inductive conductor slots 15 go to the centers of the permanent magnet units 31 and 35, and the permanent magnets 33 and 37 are arranged close to the stator as the permanent magnets 33 and 37 go to the centers of the permanent magnet units 31 and 35, the amount of magnetic flux flowing between the stator and the rotor 10 is increased, thereby increasing efficiency of the synchronous motor.

Then, if a rotational speed of the rotor 10 reaches a synchronous speed which is a rotational speed of a magnetic field generated by the stator, the rotor 10 rotates at the synchronous speed by the magnetic force generated between the conductor of the stator and the permanent magnets 33 and 37 of the rotor 10. That is, as the rotor 10 rotates by a synchronous motor, the rotational speed of the rotor 10 becomes stable.

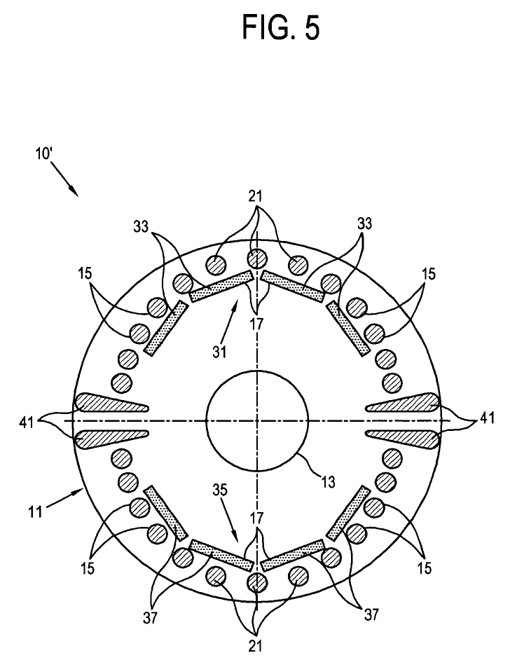

FIG. 5 is a cross-sectional view of a rotor 10′ for a synchronous motor according to another exemplary embodiment.

According to the embodiment, a plurality of inductive conductor slots 15 may have the same cross-sectional shapes and sizes.

Further, the plurality of inductive conductor slots 15 is arranged in an oval shape around a center of the shaft hole 13; and intervals of the inductive conductor slots 15 become small as the inductive conductor slots 15 go from centers of the permanent magnet units 31 and 35 to a magnetic flux loss prevention member 41.

With this configuration, the rotor 10′ according to the embodiment can prevent torque ripple and reduce vibration and noise. Further, the rotor 10′ according to the embodiment can increase an effective cross-sectional area for insertion of permanent magnets 33 and 37, thereby improving efficiency of the synchronous motor.

As described above, according to the embodiment, intervals of inductive conductor slots in which inductive conductors are inserted become small as the inductive conductor slots go from centers of permanent magnet units to a magnetic flux loss prevention member, and thus, torque ripple generated in a portion where polarities of permanent magnets are changed in driving a synchronous motor is prevented, thereby reducing vibrations and noises.

Further, a plurality of magnet slots is arranged along a plurality of inductive conductor slots which is arranged in an oval shape around a center of a shaft hole, thereby increasing an effective cross-sectional area for insertion of permanent magnets, minimizing loss of magnetic flux and improving efficiency of the synchronous motor.

Although a few exemplary embodiments have been shown and described, it will be appreciated by those skilled in the art that changes may be made in these embodiments without departing from the principles and spirit of the invention, the scope of which is defined in the appended claims and their equivalents.

What is claimed is:

1. A rotor for a synchronous motor, comprising:
a main core which is formed with a shaft hole disposed in a center area thereof, a plurality of inductive conductor slots arranged along an outer area thereof, and a plurality of magnet slots each arranged between the shaft hole and the inductive conductor slots;
an inductive conductor which is inserted into each inductive conductor slot;
a first and a second permanent magnet units which each have at least one first permanent magnet and at least one second permanent magnet having different polarities from each other, the first permanent magnet and the second permanent magnet being inserted into the magnet slots and being disposed opposite to each other with the shaft hole being interposed therebetween; and
a magnetic flux loss prevention member which is disposed between the first permanent magnet unit and the second permanent magnet unit and prevents loss of magnetic flux,
intervals between the inductive conductor slots become small as the inductive conductor slots go from centers of the first and second permanent magnet units to the magnetic flux loss prevention member.

2. The rotor according to claim 1, wherein the plurality of inductive conductor slots is arranged in an oval shape around a center of the shaft hole.

3. The rotor according to claim 2, wherein the plurality of magnet slots is arranged along an elliptical circle formed by the plurality of inductive conductor slots.

4. The rotor according to claim 2, wherein an elliptical circle formed by the plurality of inductive conductor slots has a maximum radius on a line which connects centers of the first and second permanent magnet units, and has a minimum radius on a line perpendicular to the line which connects the centers of the first and second permanent magnet units.

5. The rotor according to claim 4, wherein the maximum radius is about 0.707 to about 0.861 times as long as a radius of the main core; and the minimum radius is about 0.631 to about 0.707 times as long as the radius of the main core.

6. The rotor according to claim 1, wherein cross-sectional areas of the inductive conductor slots become big as the inductive conductor slots go from centers of the first and second permanent magnet units to the magnetic flux loss prevention member.

7. The rotor according to claim 1, wherein the plurality of inductive conductor slots have the same cross-sectional shapes and sizes.

8. The rotor according to claim 1, wherein the magnetic flux loss prevention member having approximately a wedge shape.

9. The rotor according to claim 1, wherein the magnetic flux loss prevention member having two pairs of magnetic flux loss preventing members are disposed opposite to each other with the shaft hole.

10. The rotor according to claim 1, wherein an interval Sn between an n-th inductive conductor slot and an (n+1)-th inductive conductor slot
Sₙ=S₁*0.9ⁿ⁻¹
where S₁ refers to an interval between a first inductive conductor slot and a second inductive conductor slot.

11. A line start permanent magnet (LSMP) synchronous motor having the rotor according to claim 1.
